(19) United States
(12) Patent Application Publication
(10) Pub. No.: US 2011/0221771 A1
(43) Pub. Date: Sep. 15, 2011

(54) Merging of Grouped Markers in An Augmented Reality-Enabled Distribution Network

(76) Inventors: Donald M. CRAMER, Ostrander, OH (US); David A. ELCHONESS, Niwot, CO (US); Angus C. SHEE, Boulder, CO (US)

(21) Appl. No.: 13/045,872

(22) Filed: Mar. 11, 2011

Related U.S. Application Data
(60) Provisional application No. 61/313,255, filed on Mar. 12, 2010.

(51) Int. Cl. G09G 5/00

(52) U.S. Cl. 345/633

(57) ABSTRACT

The present invention relates to systems and methods for merging smart markers in augmented reality. The system includes a server supporting the presentation of information within augmented reality of a plurality of participants. A communication network facilitates the transfer of information from the server to devices of the plurality of participants. A first participant in the plurality of participants is associated with a view of augmented reality and a plurality of smart markers, with each smart marker having an attribute. A merged group of smart markers includes smart markers from within the plurality of smart markers with said attribute being a first common attribute, wherein smart markers in the merged group are displayable within the augmented reality of the first participant.

### CROSS REFERENCE TO RELATED APPLICATIONS

The present application claims priority to and the benefit of U.S. Provisional Application No. 61/313,255, entitled “Merging of Grouped Marked in an Augmented Reality-Enabled Distribution Network,” filed on Mar. 12, 2010, which is herein incorporated by reference in its entirety.

### BACKGROUND

1. Field

The present invention relates to augmented reality.

2. Relevant Technology

Augmented Reality (AR) is a technology that enables digital data to be displayed as an information layer over a live view.

### SUMMARY

It is to be understood that the present invention includes a variety of different versions or embodiments, and this Summary is not meant to be limiting or all-inclusive. This Summary provides some general descriptions of some of the embodiments, but may also include some more specific descriptions of other embodiments.

The present invention relates to systems and methods for merging markers.

In one embodiment, a system for merging markers is disclosed. The system includes a server supporting the presentation of information within an augmented reality of a plurality of participants, a communication network for facilitating the transfer of information from said server to devices of said plurality of participants, a first participant in said plurality of participants, said first participant associated with a view of augmented reality, a plurality of smart markers displayable within said augmented reality, each smart marker within said plurality of smart markers having an attribute, and a first merged group of smart markers consisting of smart markers from within said plurality of smart markers with said attribute being a first common attribute.

In some embodiments, the plurality of smart markers are provided by the plurality of participants. In some embodiments, the attribute is a category of smart marker. The category may be selected from the group consisting of Friend, Coupon, Video, Movies, Sports, and Venue. In some embodiments, the attribute is a user permission associated with said first participant and each smart marker from among said first merged group of smart markers. In some embodiments, the user permission is a privacy rule associated with the smart marker.

In some embodiments, the system further includes a second merged group of smart markers consisting of smart markers from within said plurality of smart markers with said attribute being a second common attribute. In some embodiments each smart marker within the plurality of smart markers has a second attribute and the system further includes a third merged group of smart markers consisting of a first subgroup of smart markers having said second attribute being a third common attribute from within said first merged group of smart markers, and a second subgroup of smart markers having said second attribute being said third common attribute from within said second merged group of smart markers.

In some embodiments, the system further includes a filter for filtering said plurality of smart markers based on at least one attribute to create a merged group of smart markers displayable within said augmented reality.

In another embodiment, a computer implemented method for merging smart markers having associated categories is disclosed. The method includes receiving a plurality of smart markers associated with a first participant in an augmented reality, receiving a first user input for merging of said plurality of smart markers into a merged group of smart markers having a first common attribute, merging said plurality of smart markers to provide a group of merged markers having a common attribute, and displaying said first merged group of markers within said augmented reality.

In some embodiments, the computer implemented method further includes receiving a second user input for merging of said plurality of smart markers into a second merged group of smart markers having a second common attribute, merging said plurality of smart markers to provide a group of merged markers having a common attribute, and displaying said second merged group of markers within said augmented reality.

In some embodiments, the attribute is a category and receiving a user input includes receiving a user input indicating the selection of a particular category of smart marker. The category may be selected from the group consisting of Friend, Coupon, Video, Movies, Sports, and Venue. In some embodiments, the attribute is a related participant and wherein receiving a user input includes receiving a user input indicating the selection of a particular related participant.

In another embodiment, one or more computer readable storage media store computer executable instructions that, when executed by one or more computing processors of a computing system, cause the computing system to perform a method for merging smart markers having associated categories. The method includes receiving a plurality of smart markers associated with a first participant in an augmented reality, receiving a first user input for merging of said plurality of smart markers into a merged group of smart markers having a first common attribute, merging said plurality of smart markers to provide a group of merged markers having a common attribute, and displaying said first merged group of markers within said augmented reality.

In some embodiments, the method further includes applying a privacy rule to a smart marker in said merged group of smart markers, and providing access to said smart marker in compliance with said privacy rule.

In some embodiments, the attribute is a category and receiving a user input includes receiving a user input indicating the selection of a particular category of smart marker and wherein said merging said first group of smart markers and said second group of smart markers includes selecting a plurality of smart markers associated with said particular category.

Various components are referred to herein as “operably associated.” As used herein, “operably associated” refers to components that are linked together in operable fashion, and encompasses embodiments in which components are linked directly, as well as embodiments in which additional components are placed between the two linked components.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are understood by those of ordinary skill in the art to encompass obvious improvements and modifications thereto.

Additional advantages of the present invention will become readily apparent from the following discussion, particularly when taken together with the accompanying drawings

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a scalable and distributed augmented reality network and platform that supports the implementation of augmented reality to a plurality of users, in accordance with one embodiment of the present invention.

FIG. 2 is an illustration of an exemplary user interface on a display showing a view of augmented reality for a user, in accordance with one embodiment of the present invention.

FIG. 3 is an illustration of the merging of smart markers, in accordance with one embodiment of the present invention.

FIG. 4 is an flow diagram illustrating a method of merging of smart markers.

### DETAILED DESCRIPTION

Reference will now be made in more detail to the preferred embodiments of the present invention, systems and methods for merging groups of markers in an augmented reality-enabled distribution network. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention.

Accordingly, embodiments of the present invention exist within a distributed augmented reality-enabled network. Also, other embodiments of the present invention provide the above advantages and also provide for a mobile interface that seamlessly integrates augmented reality with the immense functionality available on mobile devices. The result is an entertaining, information-rich experience which makes every media type immediately available. Embodiments of the present invention effectively utilized location-enabled triggers and content from the user's environment offering interaction with surroundings and peers in a unique and novel manner.

### Notation and Nomenclature

Embodiments of the present invention can be implemented on a software program for processing data through a computer system. The computer system can be a personal computer, notebook computer, server computer, mainframe, networked computer (e.g., router), handheld computer, personal digital assistant, workstation, and the like. Other embodiments may be implemented through specialized hardware that is activated by a signal generated by the process that provides for the purchase, payment, and delivery of goods and services. This program or its corresponding hardware implementation is operable for the purchase and delivery of goods and services, and a payment gateway in an augmented reality distribution network. In one embodiment, the computer system includes a processor coupled to a bus and memory storage coupled to the bus. The memory storage can be volatile or non-volatile and can include removable storage media. The computer can also include a display, provision for data input and output, etc.

Some portion of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “providing,” and “merging,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

### Smart Markers Within Augmented Reality

Augmented reality (AR) blends computer generated imagery with a representation of a physical, real-world environment, and more particularly, enables digital data to be displayed as an information layer over a live view. For instance, one particular augmented reality may be associated with the live camera view of a mobile device corresponding to a user. As such, the user is presented with an individualized view of augmented reality through the live camera view.

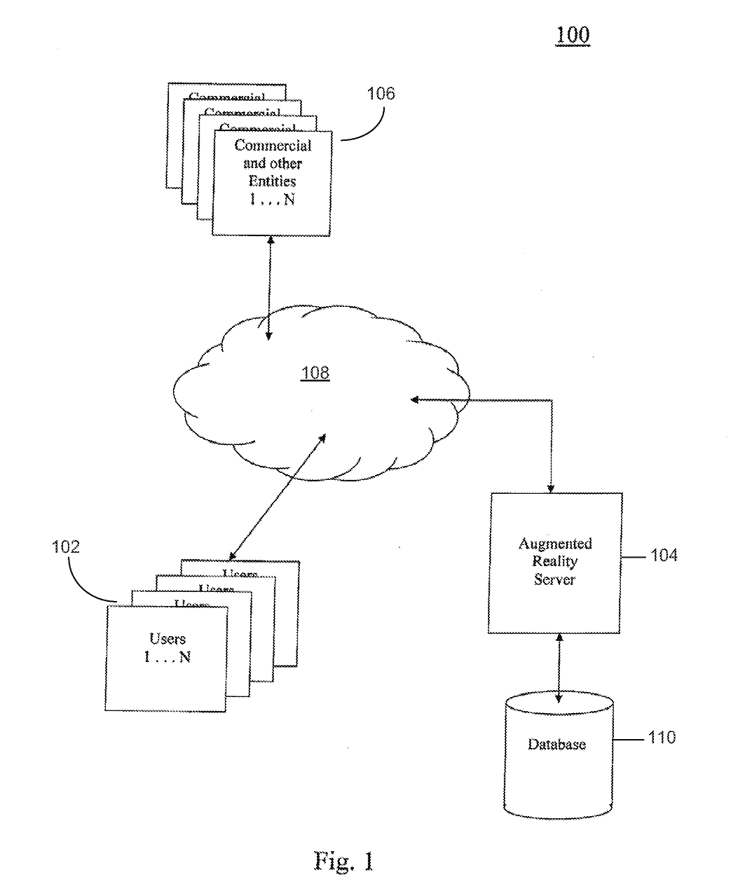

FIG. 1 is an illustration of a scalable and distributed augmented reality distribution network and platform 100 that supports the implementation of augmented reality to a plurality of users 102, in accordance with one embodiment of the present invention. In particular, an augmented reality server 104 is shown that creates and supports the augmented realities of a plurality of users 102, a plurality of commercial entities 106, and a plurality of other entities, where the plurality of augmented realities is presented on associated user devices (e.g., mobile devices, goggles, computer platforms, etc.). As such, the augmented reality server 104 is capable of presenting information overlaid on or in corresponding representations of real views for each of the plurality of users 102 and/or entities 106. Of course, the augmented reality server 104 as represented in FIG. 1 could be supported by one or more physical servers distributed throughout a communication network 108 in one or more locations.

In one embodiment, the augmented reality server 104 is capable of supporting one or more presentations of augmented realities through mobile AR platforms existing on one or more mobile devices. More particularly, the augmented reality server 104 is capable of interfacing and communicating with the AR platforms of the mobile devices so that a corresponding AR platform is able to present an appropriate augmented reality that relies on a representation of the real, live view of the world through a corresponding mobile device. Specifically, the AR platforms are capable of communicating with the augmented reality server 104 to access appropriate information that is to be displayed within a corresponding augmented reality.

For example, a mobile AR platform utilizes global positioning satellites (GPS), compass, accelerometer, and other location/position/orientation device information to display a vivid augmented reality in the camera-view of a corresponding mobile device (e.g., mobile phones) The mobile AR may use visual recognition of a specific object or landmark to determine its location. As such, the AR platform utilizes a mobile device camera or other live imaging device (goggles, etc) equipped with location technology (GPS, Wi-Fi, RFID, sensor technology, etc), compass, and accelerometer, such that one or more smart markers appears over the live view at specified coordinates.

The augmented reality server 104 functionality may be accessed by users and/or entities through any communication means. For instance, the augmented reality server 104 may be accessed through the internet, telephone communication networks, wireless communication networks, etc. Access to the augmented reality server 104 is available to manage and establish accounts, as well as utilize other features of the augmented reality network, as will be described below.

Additionally, the augmented reality server 104 is associated with a database 110. The database 110 includes information relating to profiles of corresponding users 102 and entities 106, such as name, address, and various demographic information, as well as other types of information suitable for use within the augmented reality network. This profile information is useful in managing the pluralities of users 102 and entities 106 throughout the augmented reality network.

Further, the database 110 includes information associated with the users 102 and entities 106 that is displayed or accessible in corresponding augmented realities. For instance, the term “smart marker” is used herein to represent information that is available through the augmented reality network. A smart marker enables the display and management of information in digital space that is overlaid on real-world locations. In particular, a smart marker is layered over a particular real view, to form, in part, a corresponding augmented reality view. For instance, the smart marker may appear as a digital representation (e.g., icon, three dimensional [3D] object, image, etc.) within a corresponding augmented reality at user specified coordinates in the real world. As such, the augmented reality network and platforms enable users 102 (individuals, groups, stores, corporations, and other entities) to create their own geo-located AR smart markers at any location in the physical world. Not only can users 102 create their own smart markers, but they can assign a smart marker to reside within a smart marker group within the system. For example, the system might have a sports marker group and user 102 could create a smart marker with content related to sports. The user 102 could then assign that marker to appear within the sports group that is accessible by other users in the system.

In addition, smart markers can be associated with fixed locations, or with mobile objects that are associated with inventory or individuals (e.g., mobile devices, radio frequency identifications (RFIDs), etc.) whose smart marker positions update as the related objects move. For instance, a smart marker may be associated with a physical, retail store that is a brick-and-mortar store located at a physical location having coordinates. By selecting the smart marker, additional information, relating to the retail store, can be accessed through the augmented reality platform as supported by the augmented reality server. Also, a smart marker can be associated with a mobile object, such that as the physical location of the object moves, the corresponding smart marker's location within a representation of the real world also moves. As such, the smart marker can be used to represent the moving object in real space, and to provide access to information that is related to the moving object.

Within the augmented reality network, as supported by the augmented reality server 104, users 102 and/or entities 106 create accounts and place smart markers at user-designated locations throughout the world using a network supported mobile application or a network supported integrated website.

In some embodiments, from a mobile application or platform, a user can assign coordinates representing a physical location as a smart marker location. The coordinates may correspond to the actual location of the user, at the time the coordinates are assigned, or may correspond to another physical location separate from the location of the user. In addition, the user is able to select from nearby businesses or landmarks that they can designate as a smart marker location. From the website application or platform, users can click and drop smart markers on a dynamic map, enter a known address, or search for known businesses or landmarks to assign as a smart marker's location. In both cases, multimedia files (photos, video, audio, text, etc.), links, other types of information, actions, etc., can be attached to smart markers using either the mobile application or the website.

In some embodiments, these multimedia files can be the actual digital representation of the smart marker within the augmented reality view. For example, a smart marker may be a picture of a building that a user would view within the augmented reality view at the marker's location. Triggering the multimedia files can occur by user input such as clicking the smart marker or interacting with overlaid media controls, or done automatically based on proximity of the user to the location represented by the marker. For example, as the user approaches a location represented by a smart marker having a video, the video is triggered to automatically begin playing once the user crosses a physical boundary related to the location, or when the smart marker appears within the user's augmented reality view on the mobile device.

For example, one or more actions assigned to a smart marker include, but are not limited to the following: calling a phone number; texting a number; sending an e-mail; viewing text; viewing a website; viewing multimedia—photos, video, audio, etc.; getting directions to the smart marker; commenting on the smart marker; sending the location to another user; and posting the smart marker to social networks.

Each smart marker may contain a collectible digital item that a user can acquire. This digital item can represent and contain a unique content and location of the marker. Access to the collectible digital item can be controlled based on the smart markers creator. For example, the collectible digital item may be accessible only when the user is in a predetermined physical proximity to the location represented by the marker, or the collectible digital item could be accessed using a key, such as a password, found at the physical location represented by the marker.

The user can collect the digital item, customize it by adding the user's own content such as text, photo, multimedia, video, audio, etc and share the digital item. The user may share the item to their social networks, or may send an electronic communication to another user containing a reference to the digital item, or the digital item itself In some embodiments the user may create a new smart marker and associate the digital content with the new smart marker.

The history of all the digital items that the user has collected can be accessed and edited using a view that may be sorted by any number of ways including date, location, alphabetically, favorites, etc. The digital items may also be accessed and edited in the augmented reality view based on where the digital items were originally collected, or where the digital items were left by the user.

In some embodiments, users who receive these digital items from other users can access all of the content and actions contained within each digital item, as well as interact with the digital item and the smart marker that it originated from. For example, users can collect digital “postcards” of smart markers all around the world. The postcards tell unique stories about the locations where the smart markers are dropped. Users can attach photos of themselves at these locations to the postcard and share them with all of their friends through social networks or traditional means like e-mail or SMS or MMS. Someone who receives this postcard can see the content contained within the postcard, access actions that were associated with the smart marker that the postcards originated from, including but not limited to getting directions to the smart marker, saving the smart marker location to their mobile device, or saving the content of the postcard or smart marker for their own future use.

Further, smart markers can be accessed in a number of different ways, in various embodiments. For instance, one or more smart markers is accessible through a corresponding view of augmented reality. In addition, one or more smart markers is accessible through a “Map View” that utilizes a two dimensional (2D) map, where a smart marker may be displayed relative to the user's location. Also, one or more smart markers is accessible through a “List View” that lists all smart markers within a specified range of the user. Further, a “Hybrid View” overlays a map view on the augmented reality view to display smart markers with more intuitive depth perception. This Hybrid View may include a combination of the foregoing views.

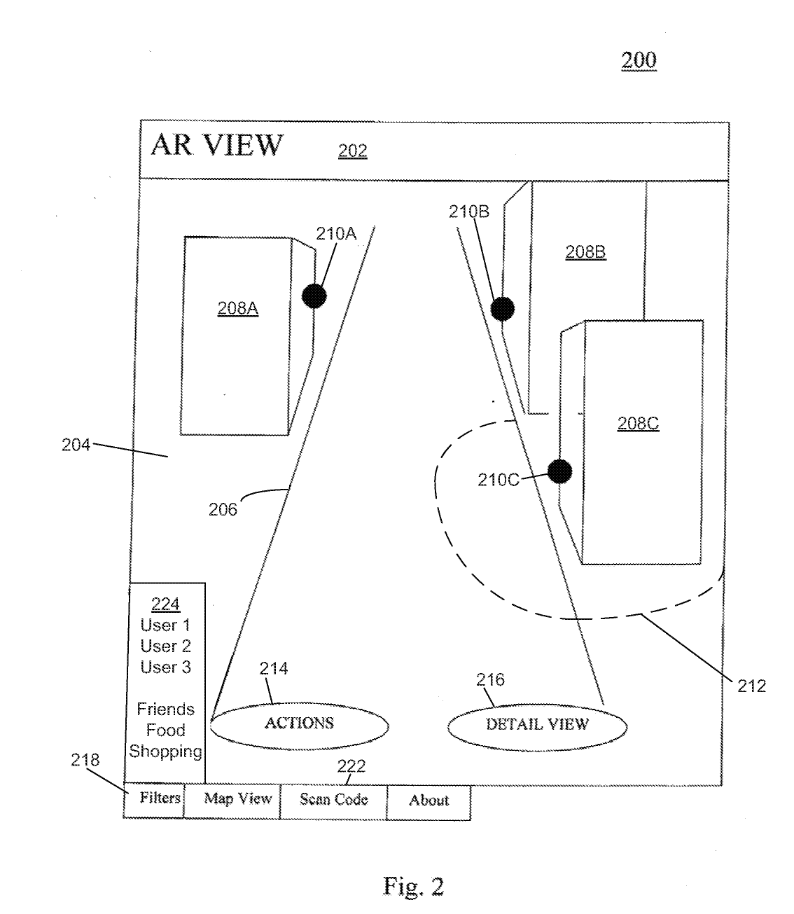

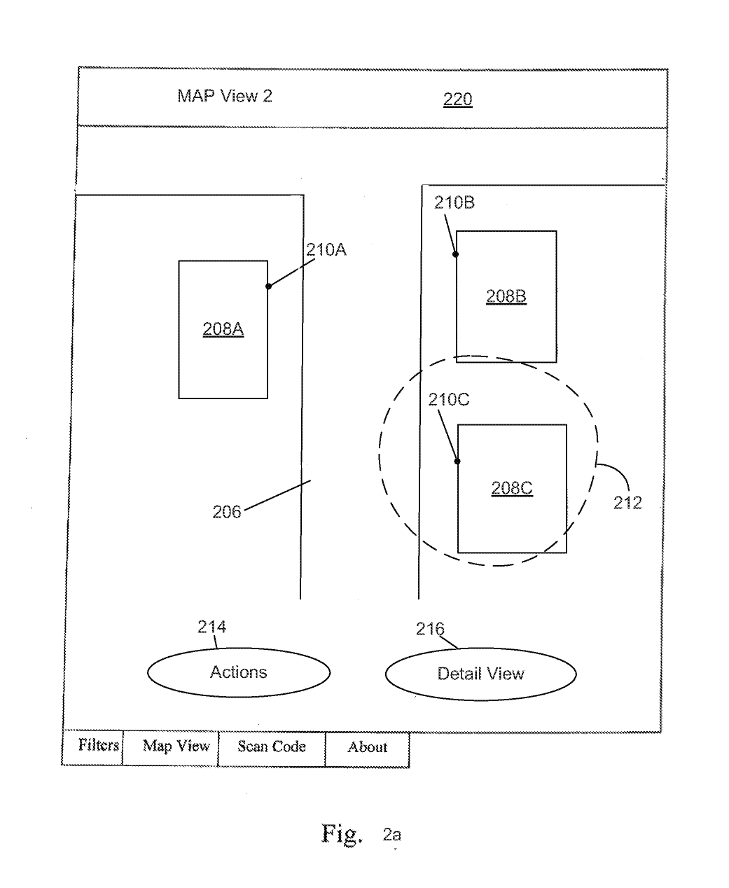

FIG. 2 is an illustration of an exemplary user interface 200 on a display showing an augmented reality view 202 for a user, in accordance with one embodiment of the present invention. As illustrated, a real and live view 204 down the middle of a street 206 is displayed. Buildings 208A, 208B, 208C are also shown on both sides of the street 206. The real, live view 204 may be from a camera of a mobile device, with the user holding the mobile device pointed down the middle of the street 206. Other live image devices may be used and supported by the augmented reality server 104, such as goggles, etc. The live view 204 is updated utilizing location, accelerometer, compass, and other orientation devices. Information is overlaid the real, live view 204 to create an augmented reality for the user using customizable mobile platform providing augmented reality enabled applications.

For instance, smart markers 210A, 210B, 210C are shown located next to the buildings 208A, 208B, 208C. Smart markers 210A, 210B, 210C can be any digital representation, such as an icon, 3D object, image, or any customizable icon, etc. that corresponds to a position within real space, and corresponding space in augmented reality. Smart markers 210A, 210B, 210C may be associated with a business (retail store, professional service, restaurant, etc.) located in a corresponding building such as smart marker 210A at building 208A, and appears at specified coordinates in the live view.

Smart markers 210A, 210B, 210C may be accessed in various ways to access information provided by the augmented reality server 104, or the AR platform on the mobile device. For instance, smart markers 210A, 210B, 210C may be accessed by clicking, either through a touch screen, or through physical buttons on the mobile device. Since the locations represented by the smart markers 210A, 210B, 210C reside in a 3D physical space, smart markers 210A, 210B, 210C that are physically further away from the location of the user, which may be the user's physical location or virtual location, can have visual characteristics that indicate the distance to the distant smart markers relative to smart markers that are closer to the user using factors such as variable size, transparency, shape, height in the view, etc. For example, smart marker 210B could be smaller than smart marker 210C. These visual characteristics allow the user to access the smart markers within a 3D space in the Y direction as they are used to doing in real life, vs. the Z direction alone as is customary on mobile devices.

Smart markers 210A, 210B, 210C can be manipulated within the augmented reality view 202 to create the appearance of “zooming in” or “zooming out” to let the user access smart markers at different distances from their location. One method of manipulating the 3D space is to variably change the appearance of smart markers 210A, 210B, 210C based on a user action such as swiping up or down on the screen (or other user input like phone rotation, verbal commands, hand gesture, eye movement, etc). In this first example, when a user swipes up on the screen, smart markers 210A, 210B, 210C further away from the user can appear to get closer to the user in the augmented reality view 202. As the user swipes down on the screen, the opposite behavior occurs.

Several methods can be used to make this augmented reality 3D experience feel natural and easy for the user. Smart markers 210A, 210B, 210C that are bunched very close together can often be skipped over due to their proximity in physical space. In these instances, a slower scroll rate or a variable distance between the smart markers 210A, 210B, 210C can be automatically incorporated. For example, the user action of swiping up/down, or other user action, on the screen can also automatically jump to subsequent smart markers at a pre-determined optimal size so that users do not have to control when the best point to stop zooming is. Smart markers 210A, 210B, 210C can also be automatically centered and stabilized in the augmented reality view 202 once the optimal size is achieved to make jumping from smart marker to smart marker a very simple process. As the user moves through space, smart markers 210A, 210B, 210C can automatically update and display at optimal viewing sizes based on the user's location. User actions can also manipulate the behavior of smart markers 210A, 210B, 210C within the augmented reality view 202. For example, swiping left and right on the screen can rotate the smart markers 210A, 210B, 210C in 3D space, or trigger an action like sending a message, or deleting a marker.

Passive notifications can let a user know about the presence of smart markers 210A, 210B, 210C in their vicinity based on their preference settings. This can be achieved by defining a customizable zone 212 around a marker 210C. When a user enters this zone 212, an action is triggered. This action can be a vibration or audible action from the phone or other device with the augmented reality view 202 to notify the user. Notifications can also be sent to designated persons with interest in the user or the smart marker 210C in question. This can used for tracking purposes or simple notifications.

Smart markers can also inform the user of nearby smart markers that the user may be interested in based on their interaction with the original smart marker. For example, smart marker 210C may identify smart marker 210B and provide visual indicators as to which direction and how far away smart marker 210B is to the user. Traditional map and text turn-by-turn directions can be overlaid in the augmented reality view 202 to supplement visual indicators such as real-time dynamically changing arrows.

Once the smart marker is selected, information (e.g., text, links, video, multimedia, etc.) is available to the user. This information is fully customizable to the creator of the smart marker. For instance, smart marker 210A may correspond to an individual, and thus is displayed at the current location of the individual. Information related to that smart marker 210A may include current information related to that individual, such as current status, whether he or she is available for quick meeting, last update information, etc. In another embodiment, a smart marker, such as smart marker 210B may correspond to a business entity, and is displayed in relation to a physical location of the business. Information related to that smart marker 210B may include current information related to the business, such as address, general information regarding the business, promotions, coupons, etc.

A smart marker may be personalized to the user. That is, a user can create and edit their own smart marker, and place it at any geo-location in real space. For example, smart marker 210A could have been created by the user and would be displayed in the augmented reality view 202 for the user. As examples, a personal smart marker may include personal notes and documentation relating to a landmark. Additionally, the personal smart marker may be shared with others, so that they can view the user's smart marker in their augmented reality.

The “Actions” button 214 provides user access to additional technology. For example, one or more actions assigned to a smart marker include, but are not limited to the following: calling a phone number; creating voice memo, texting a number; sending an e-mail; viewing text; accessing and viewing a website; viewing multimedia—photos, video, audio, etc.; getting directions to the smart marker; commenting on the smart marker; sending the location to another user; and posting the smart marker to social networks.

The “Detail View” button 216 provides additional in-depth details of selected assets relating to the smart marker.

The viewable smart markers 210A, 210B, 210C in augmented reality may be further filtered. As such, the filter option 218 allows a user to display and view only desired smart markers, such as desired categories of smart markers, or filtering using specific search criteria, as supported by the search engine (not shown) in association with the augmented reality server 104. As another example, a filter may designate the range or distance from the user within which smart markers are displayed.

In addition, smart markers 210A, 210B, 210C may be viewed in other views. For instance, as shown in FIG. 2A, smart markers 210A, 210B, 210C may be viewed in map view 220. As such, instead of a view of 3D space in augmented reality as in AR View 202, the map view 220 provides a top down 2D view of space, with smart markers 210A, 210B, 210C located using map coordinates corresponding to specific locations of businesses, landmarks, personal points of interest, etc.

In addition, a scanner may be included. The scan code button 222 enables built in tag reader functionality, such as the ability to process common codes, such as bar codes or quick response (QR) codes, etc. Codes read by the scanner can launch the same behavior as is described for smart markers.

The display showing an augmented reality may include other options. For instance, a legend may be implemented displaying filtering options. The legend may include various categories of smart markers or content categories, such as “Friend,” “Coupon,” “Video,” “Movies,” “Sports,” and “Venue.” Further, these categories, and the corresponding smart markers they are associated with may be color, size, shape-coded, or otherwise identifiable within the augmented reality. The Friend category is related to smart markers of friends of the user. The Coupon category is related to smart markers that provide or are linked to coupon offers. The Video category may be related to smart markers providing video content. And the Venue category may be related to smart markers associated with special venues (e.g., concert hall) or businesses. In this way, a user can quickly distinguish between displayed smart markers 210A, 210B, 210C.

The user can also turn each of these categories on/off directly from the legend in the augmented reality view 202. Turning a category off removes all the smart markers within that category from the augmented reality view 202. The legend can be updated in real-time displaying categories with smart markers nearby or categories marked as “favorites” of the user. As the user physically moves through to a new location, the legend updates based on the new location and the user's preferences. The legend can visually identify which categories are available, which are favorites, and which are turned on. Categories can also be displayed within the legend based on popular categories in the region determined by the number of smart marker views within each category by other users, or by predicted user interests based on the user's previous actions (locations traveled, smart markers viewed, spending habits, etc) or user profile (lifestyle, age, interests, etc). The user can also input a search term that locates all smart markers that fit the search term and return the results from multiple categories in the augmented reality view 202.

A user can also have the ability to prioritize how smart markers appear within each of the categories. Smart markers that a user does not wish to see anymore can be hidden from the augmented reality view 202. Favorite smart markers can be given priority to display over other smart markers in the area.

The display may show a radar view of all smart markers within the general vicinity of the user. For instance, the radar view displays smart markers relative to the user location using 2D radar mapping. As such, smart markers within a general range are shown on the radar map relative to the user's position. In addition, the view of the map may be oriented such that the user directionality is displayed relative to asset or smart marker locations. The view of the map, is updated as the user moves. Additional details and information is displayable. For instance, a coupon may be provided within the display that is associated with a selected smart marker, or may be generally displayed since the user is within the vicinity of the business establishment.

### Grouping and Merging of Smart Markers in Augmented Reality

Once users are participating within the augmented reality network and platforms as supported by the back-end augmented reality server, a user can “friend” or “follow” other users (e.g., individuals, groups, entities, etc.) by merging smart marker streams and create an augmented world filled with pertinent user-generated content. In particular, these virtual smart markers can be combined into groups that are linked together under a common factor (user, group, company, etc).

For instance, smart markers may be merged into and unmerged from independently created and grouped virtual smart markers for a user. Each group of smart markers is associated with a corresponding participant (e.g., individual, entity, etc.). The merged group of smart markers is displayable into a single cohesive view. Within the single cohesive view, each displayed group may have a unique visual identifier (icon, 3D object, image) to distinguish one group from another within a view of augmented reality. The single cohesive view can take the form of an augmented reality, map, list, or hybrid view on the mobile application or network website.

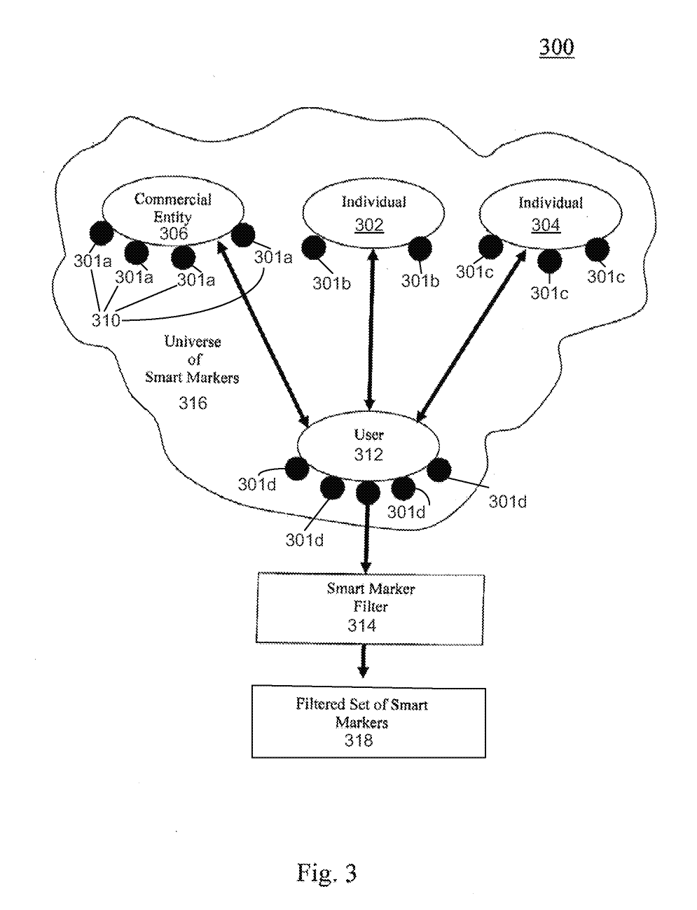

FIG. 3 is an illustration of the merging of smart markers 301, in accordance with one embodiment of the present invention. Smart markers 301A, 301B, 301C, 301D may be associated with an individual, such as individual 302 or 304, or any type of entity (e.g., commercial, retail, group, etc.) such as commercial entity 306, referred to as a participant. A group of smart markers includes one or more smart markers, and may be associated with a particular participant. For instance, the commercial entity 306 is associated with smart marker group 310 that includes public smart markers 301A available to any participant. Individuals may be associated with private or public smart markers available for merging, where authorization is needed before private smart markers may be accessed. For example, individual 302 may be associated with smart markers 301B which could be private and individual 304 may be associated with smart markers 301C which could be public. As described previously, smart markers 301A, 301B, 301C for a participant in a corresponding account may be further categorized or organized. Also, as shown, a user 312 may also be associated with one or more smart markers 301D, which could be private or public, as designated by the user 312.

In addition, the user 312 has access to a merged group of smart markers 301A, 301B, 301C, all of which are selectable by the user 312 for inclusion within the user's augmented reality. In addition to the user's 312 own smart markers 301A , the merged group includes smart markers 301A, 301B, 301C from other participants in the augmented reality network, such as smart markers 301A in an account of a commercial entity (e.g., burger chain), and smart markers 301B, 301C from accounts of two other individuals 302, 304 (e.g., friends) that have authorized the user 312 to access their smart markers 301B, 301C.

Within the merged group of smart markers 301A, 301B, 301C, the various user accounts associated with each smart marker 301A, 301B, 301C can be classified into categories such as travel, friends, restaurants, etc. These user accounts are associated with a group of smart markers for that user. For example, commercial entity 306 has a user account associated with smart marker group 310. The user 312 can elect to turn all the individual accounts within a particular category “on” or “off” For instance, the user 312 may elect to turn off all smart markers from entities labeled within the restaurant category. Also, the user 312 may elect to turn on only smart markers from entities labeled within the restaurant category. This gives the user 312 very quick access to related data without having to select and un-select multiple accounts.

The merging and un-merging of smart markers from various accounts associated with various participants can be further managed using a digital filter system 314. That is, displayed smart markers in the universe 316 can be filtered according to user preferences based on any number of criteria, such as specific people, smart marker types, location, subject matter, etc. As an example, a digital filter system 314 allows the user 312 to display a filtered set 318 of smart markers containing only certain categories of smart markers within the universe 316 of smart markers available to the user 312. Smart marker categories can be filtered by subject matter, time, location, etc. Smart markers in the filtered set 318 of smart markers are displayed within a single cohesive view of the augmented reality for the user 312.

As a result, the combination of merging and un-merging groups and a digital filter enables the user to identify and isolate only the pertinent data that they want immediate access to. Users have full control of merging and unmerging groups within their own customized unique view of augmented reality.

Privacy rules may be implemented such that only users who have been granted permission, can view a particular user's smart markers. For instance, commercial entity 306, the owner of smart marker group 310, could control if individual 302, individual 304, or user 312 has access to view and interact with the commercial entity's smart markers 301A. When signing up for an account, a user has the option to own a private or a public account. In one case, a private account, for an individual or group, mutual consent is required for viewing and merging of the groups. That is, it requires both or all parties to approve before smart markers can be shared and viewed by a requesting party.

In another example, smart markers can represent the mobile location of a user within the network, users have the ability to control which members of the network can view their physical location. For example, referring back to FIG. 2, smart marker 210A could refer to the location of a user. This can be broadly controlled by the privacy rules described above, but can also be further controlled by the user. The user can further limit among the people they have given access to their smart markers, who can view their position by checking or un-checking names from a list of approved users from the mobile application or network website.

However, a public account allows any user full access to the smart markers created from the public account. That is, in a designated public account, all users of the network have access to the smart markers once the group is selected.

Referring to FIG. 2, a legend 224 can be incorporated within each view of augmented reality to help users identify each group/filter name and corresponding visual identifier. The legend may also include a list of categories that may be selected. For example, legend 224 displays a list of users and a list of categories. A user has the ability to search in the augmented reality network for new groups and choose to add or remove smart markers from corresponding accounts in the universe of smart markers from their single cohesive view. That is, a user is able to search through a universe of smart marker groups associated with a plurality of participants of the augmented reality network to find favorable groups or accounts of smart markers. The user is then able to add the new group to the legend 224.

Favorite filterings of smart markers can be saved using bookmarks to allow easy access to merge and un-merge smart markers from the selected view. In particular, a favorite search term achieving results (e.g., groups of smart markers) that the user likes and wishes to save may be bookmarked. As such, the search term or terms are bookmarked for later access and re-processing. As an example, in a universe of available smart markers, a search can be made for groups of smart markers related to restaurants. Also, in the merged group of smart markers, a search can be made for smart markers related to restaurants. In both cases, the search term or terms may be bookmarked for later re-processing to access the same or similar result. In some embodiments, a reference to the bookmark may be included in the legend 224.

Within this augmented reality social network, premium groups or “channels” are available for users to “subscribe” to and have the channel's augmented reality data merge into their cohesive view. Smart markers associated with the channel are prominently displayed within the augmented reality network and mobile application for all users to access if they so choose. Channels may contain high quality content and a geographically wide range of accessible data. These channels are the equivalent to network stations in television as standard grouped smart markers are to public access stations.

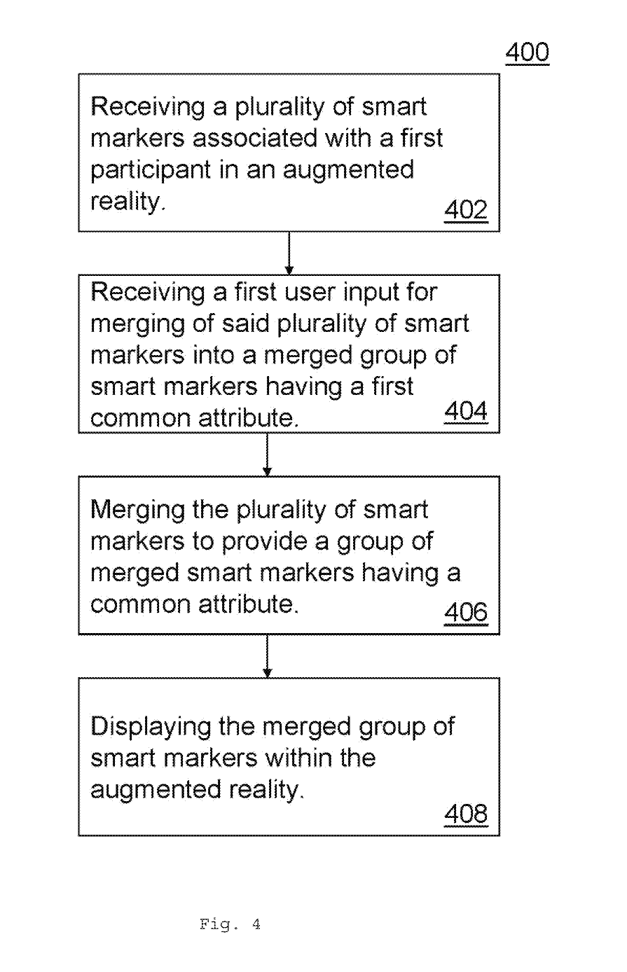

FIG. 4 is a flow diagram illustrating an embodiment of a method 400 for merging smart markers. The method will be explained with respect to FIG. 1. The method includes receiving 402 a plurality of smart markers associated with a first participant in an augmented reality. A first user input for merging of said plurality of smart markers into a merged group of smart markers having a first common attribute is received 404. The plurality of smart markers are merged 406 to provide a group of merged smart markers having a common attribute. The merged group of smart markers is then displayed 408 within the augmented reality.

For example, a device corresponding to user 102 could receive a plurality of smart markers associated with the user 102 from augmented reality server 104 through communications network 108. The device corresponding to user 102 could receive an input from user 102 indicating the selection of a group of smart markers. The device corresponding to user 102 could merge the plurality of smart markers. The device corresponding to user 102 may then display said merged group of smart markers within said augmented reality. In some embodiments, the augmented reality server 104 could receive an input from user 102 through communications network 108 and the augmented reality server 104 could merge the plurality of smart markers.

Method 400 may be implemented by a computer system. The computer system may have one or more computer readable storage media storing instructions, that when executed by a one or more processors of the computing system cause the computing system to perform method 400. For example, a user's personal electronic device may have a storage media with computer executable instructions for implementing method 400. In other embodiments, the computer executable instructions may be stored in a plurality of locations such as augmented reality server 304 and a user's personal electronic device.

A system and method for merging groups of smart markers in an augmented reality-enabled distribution network is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

We claim:

1. A system for merging smart markers, the system comprising:
a server supporting a presentation of information within an augmented reality of a plurality of participants;
a communication network for facilitating the transfer of information from said server to devices of said plurality of participants;
a first participant in said plurality of participants, said first participant associated with a view of augmented reality;
a plurality of smart markers displayable within said augmented reality, each smart marker within said plurality of smart markers having an attribute; and
a first merged group of smart markers consisting of smart markers from within said plurality of smart markers with said attribute being a first common attribute.

2. The system of claim 1, wherein said plurality of smart makers are provided by said plurality of participants.

3. The system of claim 1, the system further comprising a second merged group of smart markers consisting of smart markers from within said plurality of smart markers with said attribute being a second common attribute.

4. The system of claim 3, wherein each smart marker within said plurality of smart markers has a second attribute, the system further comprising a third merged group of smart markers consisting of:
a first subgroup of smart markers having said second attribute being a third common attribute from within said first merged group of smart markers; and
a second subgroup of smart markers having said second attribute being said third common attribute from within said second merged group of smart markers.

5. The system of claim 1, wherein said attribute is a category of smart marker.

6. The system of claim 1, wherein said attribute is a user permission associated with said first participant and each smart marker from among said first merged group of smart markers.

7. The system of claim 5, wherein said category is selected from the group consisting of Friend, Coupon, Video, Movies, Sports, and Venue.

8. The system of claim 6, wherein said user permission is a privacy rule associated with said smart marker.

9. The system of claim 1, further comprising:
a filter for filtering said plurality of smart markers based on at least one attribute to create a merged group of smart markers displayable within said augmented reality.

10. A computer implemented method for merging smart markers having an associated attribute, the computer implemented method comprising:
receiving a plurality of smart markers associated with a first participant in an augmented reality;
receiving a first user input for merging of said plurality of smart markers into a merged group of smart markers having a first common attribute;
merging said plurality of smart markers to provide a group of merged smart markers having a common attribute; and
displaying said first merged group of smart markers within said augmented reality.

11. The computer implemented method of claim 10 further comprising:
receiving a second user input for merging of said plurality of smart markers into a second merged group of smart markers having a second common attribute;
merging said plurality of smart markers to provide a group of merged smart markers having a common attribute; and
displaying said second merged group of smart markers within said augmented reality.

12. The computer implemented method of claim 11 wherein said attribute is a category and wherein receiving a user input includes receiving a user input indicating the selection of a particular category of smart marker.

13. The computer implemented method of claim 11, wherein said attribute is a related participant and wherein receiving a user input includes receiving a user input indicating the selection of a particular related participant.

14. The computer implemented method of claim 11 further comprising:
applying a privacy rule to a smart marker in said merged group of smart markers; and
providing access to said smart marker in compliance with said privacy rule.

15. The computer implemented method of claim 13, wherein said category is selected from the group consisting of Friend, Coupon, Video, Movies, Sports, and Venue.

16. A computer program product for implementing a method merging smart markers having associated categories, the computer program product comprising one or more computer readable storage media having stored thereon computer executable instructions that, when executed by one or more computing processors of a computing system, cause the computing system to perform the method, the method comprising:
receiving a plurality of smart markers associated with a first participant in an augmented reality;
receiving a first user input for merging of said plurality of smart markers into a merged group of smart markers having a first common attribute;
merging said plurality of smart markers to provide a group of merged smart markers having a common attribute; and
displaying said first merged group of smart markers within said augmented reality.

17. The computer program product of claim 16, wherein said method further comprises:
applying a privacy rule to a smart marker in said merged group of smart markers; and
providing access to said smart marker in compliance with said privacy rule.

18. The computer program product of claim 16, wherein said attribute is a category and wherein said receiving a user input includes receiving a user input indicating the selection of a particular category of smart marker and wherein said merging said first group of smart markers and said second group of smart markers includes selecting a plurality of smart markers associated with said particular category.
